(19) United States
(12) Patent Application Publication
(10) Pub. No.: US 2008/0297691 A1
(43) Pub. Date: Dec. 4, 2008

(54) BACK LIGHT UNIT AND LIQUID CRYSTAL DISPLAY WITH THE SAME

(76) Inventors: Shawn Kim, Suwon (KR); Sang-uk Kim, Suwon (KR); Mu-kyung Jeon, Suwon (KR); Jin-woo Park, Suwon (KR); Youn-bum Lee, Suwon (KR); Tae-soo Kim, Suwon (KR)

Correspondence Address: CHRISTIE, PARKER & HALE, LLP, PO BOX 7068, PASADENA, CA, 91109-7068, US

(21) Appl. No.: 12/103,113

(22) Filed: Apr. 15, 2008

(30) Foreign Application Priority Data
May 29, 2007 (KR) 10-2007-0051995

(51) Int. Cl. G02F 1/13357

(52) U.S. Cl. 349/64

(57) ABSTRACT

A back light unit for a liquid crystal display panel including a light source, a light guide plate for receiving light from the light source, a lower surface of the light guide plate coated with a reflection sheet, wherein the reflection sheet may be metal, a diffuser for diffusing the light from the light guide plate, and an optical sheet for providing the light from the diffuser to the liquid crystal display panel.

### CROSS-REFERENCE TO RELATED APPLICATION

This application claims priority to and the benefit of Korean Patent Application No. 10-2007-0051995, filed on May 29, 2007, in the Korean Intellectual Property Office, the entire content of which is incorporated herein by reference.

### BACKGROUND

1. Field of the Invention

The present invention relates to a liquid crystal display device, and more particularly to a back light unit for a liquid crystal display device.

2. Discussion of Related Art

With the rapid development of the information and communication industries, the use of display devices has rapidly expanded. Recently, there is demand for a display device having relatively low power, light weight, a thin profile, and high resolution. To meet such a demand, liquid crystal display devices or display devices using organic luminescence properties have been developed.

A thin film transistor-liquid crystal display (TFT-LCD) having excellent color reproduction properties and low power consumption is an example of a flat panel display device. The TFT-LCD includes a liquid crystal display panel, a back light unit, and an LCD drive IC (LDI). In the liquid crystal display panel, a liquid crystal is injected between two substrates. The back light unit is located under the liquid crystal display panel, and is used as a light source. The LDI drives the liquid crystal display panel.

In some back light units, a reflection sheet includes a dielectric substance such as a polymer compound, that complicates manufacturing of the reflection sheet. Furthermore, since a space is required between the reflection sheet and the light guide plate, a thickness of the back light unit is greater than it otherwise would be without the space.

### SUMMARY OF THE INVENTION

An aspect of an embodiment of the present invention is directed toward a back light unit that can increase light efficiency by improving a reflection structure of a light guide plate, and also simplify manufacturing of a thin liquid crystal display device by making the back light unit relatively thin.

In an exemplary embodiment of the present invention, a back light unit for a liquid crystal display panel is provided to include a light source, a light guide plate for receiving light from the light source, a lower surface of the light guide plate including a reflection sheet, a diffuser for diffusing the light from the light guide plate, and an optical sheet for providing the light from the diffuser to the liquid crystal display panel. In one exemplary embodiment, the reflection sheet may be metal, such as aluminum or silver.

In one exemplary embodiment, an entire lower surface of the light guide plate may be directly coated with the reflection sheet such that there is no space between the reflection sheet and the light guide plate. Additionally, the back light unit may be incorporated into a liquid crystal display device.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic cross-sectional view of a structure of a general back light unit.

FIG. 2 is a schematic exploded perspective view of a liquid crystal display device according to an exemplary embodiment of the present invention.

FIG. 3 is a schematic cross-sectional view of a back light unit according to an exemplary embodiment of the present invention.

### DETAILED DESCRIPTION

In the following detailed description, only certain exemplary embodiments of the present invention are shown and described, by way of illustration. As those skilled in the art will recognize, the invention may be embodied in many different forms and should not be construed as being limited to the embodiments set forth herein. Like reference numerals designate like elements throughout the specification.

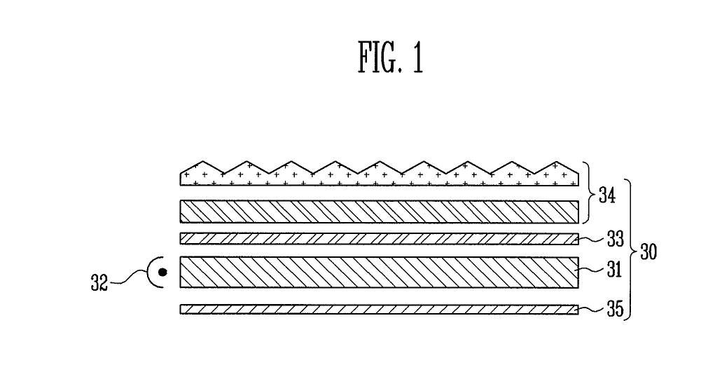

FIG. 1 is a cross-sectional view showing a structure of a back light unit. Referring to FIG. 1, the back light unit 30 includes a light source 32, a light guide plate 31, a diffuser 33, an optical sheet 34, and a reflection sheet 35. The light source 32 includes a lamp and a reflection plate, the lamp being located on one side of the light guide plate 31 and the reflection plate reflecting light emitted from the lamp toward a liquid crystal display panel via the light guide plate 31. The light guide plate 31 has a pattern, for example, a dot pattern, and serves to change a distribution of the light provided from the light source 32 to a liquid crystal display panel. The diffuser 33 diffuses the light from the light guide plate 31 to uniformly distribute the luminance of the light, and the optical sheet 34, including a plurality of prism sheets, improves vertical incidence. For example, the optical sheet 34 may include a first prism and a second prism having V-shaped grooves thereon. The reflection sheet 35 reflects light emitted from the light source 32 to the light guide plate 31.

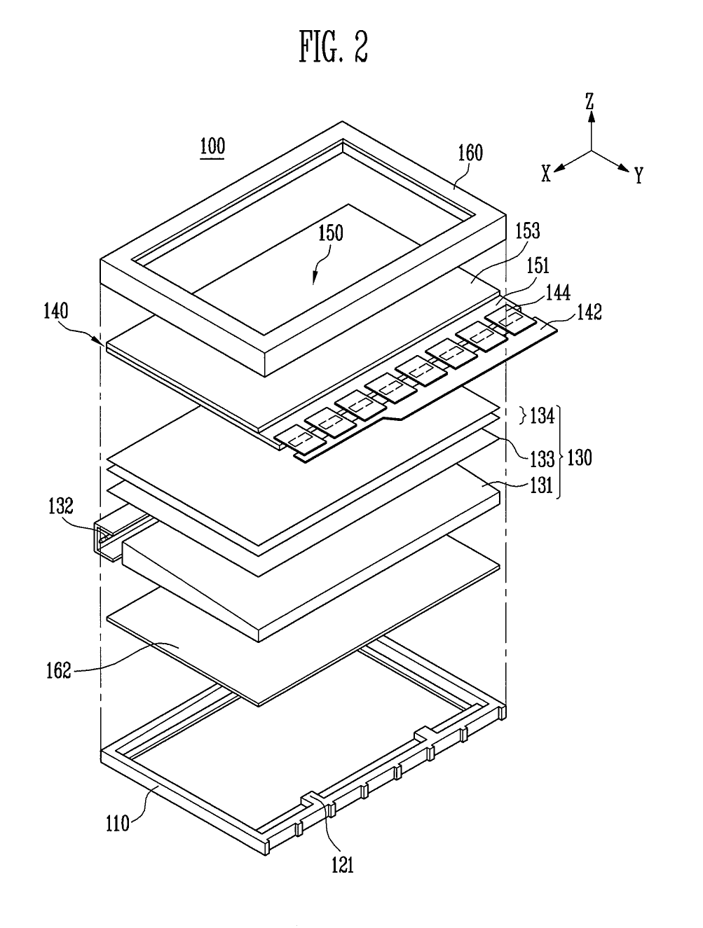

With reference to FIG. 2, a liquid crystal display device 100 includes a back light unit 130, a liquid crystal display panel 140, a top (or first) chassis 160, a bottom (or second) chassis 162, and a mold frame 110 having supports 121. The back light unit 130 provides light to allow the liquid crystal display panel 140 to display images. The top chassis 160, the bottom chassis 162, and the mold frame 110 fix the back light unit 130 and the liquid crystal display panel 140.

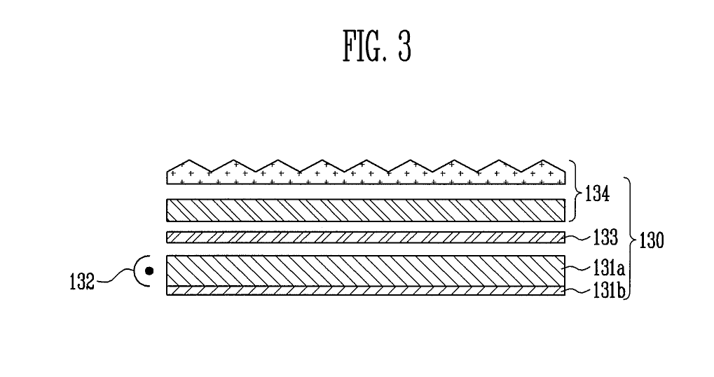

The back light unit 130 is supported by the bottom chassis 162 located below the back light unit, the bottom chassis 162 being fixed within the mold frame 110. The back light unit 130 includes a light guide plate 131 for directing light emitted from a lamp. In one embodiment, the lamp is a light emitting diode (LED). However, other suitable light sources, such as a surface light source or a line light source, can be used as the lamp. A lower portion of the light guide plate 131 is coated with a reflection sheet 131b (FIG. 3) for reflecting light. A plurality of optical sheets 134 are located proximate to the light guide plate 131, each optical sheet 134 including a first prism sheet and a second prism sheet. A diffuser 133 is formed between the light guide plate 131 and the optical sheets 134.

The liquid crystal display panel unit 140 includes a liquid crystal display panel 150, a printed circuit board (PCB) 142, and a tape carrier package (TCP) 144. The liquid crystal display panel 150 includes a TFT substrate 151 having a thin film transistor, a color filter substrate 153 on an upper portion of the TFT substrate 151, and a liquid crystal between the TFT substrate 151 and the color filter substrate 153. Polarizers are attached to an upper portion of the color filter substrate 153 and a lower portion of the TFT substrate 151 for determining a polarized direction of visible light emitted from the back light unit 130.

In the TFT substrate 151, a thin film transistor is formed on a transparent substrate in a matrix. A source of the thin film transistor is coupled to a data line, a drain of the thin film transistor coupled to a pixel electrode, and a gate of the thin film transistor is coupled to a scan line. Here, the pixel electrode includes an indium tin oxide (ITO) conductive material. A scan signal transferred through the scan line determines on/off of the TFT to transfer an electric signal from the source thereof to the drain. An arrangement of a liquid crystal is changed according to the electric signal to thereby determine the transmittance of light.

In the color filter substrate 153, when light passes through a liquid crystal, the light passes through a color filter to indicate a specific color, and a gradation us expressed according to the transmittance of the light.

The PCB 142 transfers a data signal and a scan signal to the TFT substrate 151, and is fixed to the TFT substrate 151 by the TCP 144.

Referring to FIG. 3, the back light unit 130 of an exemplary embodiment of the present invention includes a light source 132, a light guide plate 131a, a diffuser 133, and an optical sheet 134. The light guide plate 131a alters light concentrated on a narrower area to be uniformly distributed through a wider area and may comprise a transparent material such as acrylic resin having a substantially rectangular shape. A lower surface of the light guide plate 131a is coated with a reflection sheet 131b including a metal such as silver or aluminum. The diffuser 133 diffuses the light from the light guide plate 131a to uniformly distribute the luminance of the light, and the optical sheet 134, including a first prism sheet and a second prism sheet improves vertical incidence.

A general reflection sheet is formed of polymer material. The reflection sheet 131b in one exemplary embodiment of the present invention includes metal, thereby simplifying the manufacturing of the reflection sheet 131b as well as decreasing the cost of manufacture. Because the lower surface of the light guide plate 131a is directly coated with the reflection sheet 131b, there is no space between the light guide plate 131a and the reflection sheet 131b, thereby preventing (or reducing) a dispersion of light and increasing the light efficiency. Furthermore, the lack of a space between the light guide plate 131a and the reflection sheet 131 allows for a thinner liquid crystal display device.

The light source 132 includes a lamp adjacent a light guide plate. At least one LED or cold cathode tube (fluorescent lamp) may be used as the lamp. In the liquid crystal display device according an exemplary embodiment of the present invention, the reflection sheet is located at a lower surface of the light guide plate to prevent or reduce light loss. Furthermore, when the reflection sheet is composed of metal such as silver or aluminum, the manufacturing of the liquid crystal display device is simplified and the cost is reduced as compared to using a dielectric (or polymer) substance. In addition, since the reflection sheet is in direct contact with the light guide plate, there is no space between the light guide plate and the reflection sheet, allowing a thinner back light unit, and therefore a thinner liquid crystal display device.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What si claimed is:

1. A back light unit, comprising:
a light source;
a light guide plate for receiving light from the light source, a lower surface of the light guide plate being coated with a reflection sheet;
a diffuser for diffusing the light provided from the light guide plate; and
an optical sheet for providing the light from the diffuser to a liquid crystal display panel.

2. The back light unit as claimed in claim 1, wherein the reflection sheet comprises metal.

3. The back light unit as claimed in claim 1, wherein an entire lower surface of the light guide plate is coated with the reflection sheet.

4. The black light unit as claimed in claim 1, wherein there is no space between the reflection sheet and the light guide plate.

5. The black light unit as claimed in claim 1, wherein the reflection sheet is in direct contact with the light guide plate.

6. A back light unit for a liquid crystal display panel comprising:
a light source;
a light guide plate for receiving light from the light source, a lower surface of the light guide plate comprising a metal reflection sheet;
a diffuser for diffusing the light from the light guide plate; and
an optical sheet for providing the light from the diffuser to the liquid crystal display panel.

7. The back light unit as claimed in claim 6, wherein the metal reflection sheet comprises at least one of aluminum or silver.

8. The back light unit as claimed in claim 6, wherein an entire lower surface of the light guide plate is coated with the reflection sheet.

9. The black light unit as claimed in claim 6, wherein there is no space between the metal reflection sheet and the light guide plate.

10. The black light unit as claimed in claim 6, wherein the metal reflection sheet is in direct contact with the light guide plate.

11. A liquid crystal display device comprising:
a liquid crystal display panel for receiving light to display images; and
a back light unit for providing the light to the liquid crystal display panel,
wherein the back light unit includes:
a light source;
a light guide plate for receiving light from the light source, a lower surface of the light guide plate being coated with a reflection sheet;
a diffuser for diffusing the light from the light guide plate; and
an optical sheet for providing the light from the diffuser to the liquid crystal display panel.

12. The liquid crystal display device as claimed in claim 11, wherein the reflection sheet comprises metal.

13. The liquid crystal display device as claimed in claim 12, wherein the metal is aluminum.

14. The liquid crystal display device as claimed in claim 12, wherein the metal is silver.

15. The liquid crystal display device as claimed in claim 11, wherein an entire lower surface of the light guide plate is coated with the reflection sheet.

16. The liquid crystal display device as claimed in claim 11, wherein there is no space between the reflection sheet and the light guide plate.

17. The liquid crystal display device as claimed in claim 11, wherein the reflection sheet is in direct contact with the light guide plate.
